(19) United States
(12) Patent Application Publication
(10) Pub. No.: US 2019/0251863 A1
(43) Pub. Date: Aug. 15, 2019

(54) INTERACTIVE TRAINING APPARATUS AND RELATED KIT

(71) Applicant: Peter CROOKER, North Kingstown, RI (US)

(72) Inventor: Peter CROOKER, North Kingstown, RI (US)

(21) Appl. No.: 15/896,965

(22) Filed: Feb. 14, 2018

(51) Int. Cl. G09B 19/16; G09B 1/32; G09B 19/00; G09B 19/14

(52) U.S. Cl. CPC G09B 19/167; G09B 1/32; B43L 1/00; G09B 19/14; G09B 19/003

(57) ABSTRACT

An apparatus and kit for interactive training within a rail system. The apparatus includes a table board illustrating generalized rail system lines. User pieces are provided for placement on the table board during interactive training. The user pieces are customizable via labels provided on one or more adhesive sheets.

### FIELD OF THE INVENTION

The present invention relates generally to instructional training devices and more particularly to a board and pieces representative of railroad operations and the like.

### BACKGROUND OF THE INVENTION

In the field of training and instruction with specific regard to railroad operations, standard methods of educating personnel includes providing operations manuals to employees with corresponding classroom lectures. Such known methods may also involve home study along with testing by written or computer-administered examinations.

In the general field of railway simulation, there are known inventions including U.S. Pat. No. 4,041,283 which is a railway train control simulator and method granted to Mosier and U.S. Pat. No. 5,066,015 which is a board game apparatus and method of playing granted to Sumrall.

U.S. Pat. No. 4,041,283 to Mosier discloses a method and apparatus for simulating operation and control of a railway train having at least one locomotive in a locomotive set and a plurality of articulated cars. A simulator control station including a train speed control throttle and a train braking controller provides signals related to the degree of operation of the throttle and braking controller. Information relating to car consist, track profile and simulated train location for a predetermined section of track are provided together with data related to the simulated locomotive tractive effort and train braking. Coupling forces between each car throughout the extent of the train are calculated from the data and displayed at the simulator control station to enable a simulator control station operator to control the throttle and braking controller in response to the displayed coupling forces and thereby simulate operation and control of the train. Brake pressure distribution along the length of the train is also displayed.

U.S. Pat. No. 5,066,015 to Sumrall discloses a board game based on a railroad theme is provided wherein the players each assemble the necessary components of a complete railroad train, under rules simulating conditions normally existing in the marshalling yard of a conventional railroad system. The gameboard has a playing surface depicting the trackage, switches and other elements of a marshalling yard. A plurality of playing pieces represent the players and have a changeable status or rank. Other pieces are included which represent messages sent from the yard dispatcher to the players during play of the game and train components. The tokens are moved about the trackage according to values established by casting dice, by the use of a spinner, or other chance device for establishing values at random. The goal of each player is to acquire a locomotive, and thereafter to collect all of the other rolling stock needed to make up a complete train, before any of the other players. However, each player begins the game with the rank of “fireman”, and before being entitled to operate a locomotive and to collect any of the rolling stock, must first achieve promotion to the rank of “engineer”. The rank of “engineer” is denoted by a small playing piece in the shape of a hat which is placed onto the head of the “fireman”.

In the general field of utility distribution systems, U.S. Pat. No. 5,163,241 is a display board and modules therefor granted to Blaeser et al. and which discloses a display board for illustrating an electrical power distribution system or the like comprises a matrix of rectangular modules magnetically attached to a steel support board. The modules may comprise die cut steel base plates backed by sheets of magnetic rubber. Relatively permanent background graphics are silk screened upon the front faces of the modules. Foreground graphics representing features which are subject to change may be overprinted upon the background graphics in an ink which may be removed without disturbing the background graphics.

In the general field of traffic law and regulation instruction, U.S. Pat. No. 5,259,623 is a driver education board game granted to Kanelos, Sr. and which discloses a board game teaching traffic laws and regulations provides a peripheral playing path about the perimeter of a rectangular board and further inwardly located paths. The inwardly located paths are provided for the purpose of various examinations or tests to be undertaken by each player during the course of the game. The first player to successfully complete the written examination, eye examination, and road test portions of the game is declared the winner. However, other questions and requirements must be satisfactorily responded to during the portion of play which takes place along the peripheral playing path of the game board.

In the general field of industrial safety rule instruction, U.S. Pat. No. 5,722,658 is a safety board game granted to Talmage et al. and is a board game apparatus for teaching industrial safety rules and procedures includes a game board, playing pieces, question cards and a score card. The game board includes a representation of various component parts of an industrial organization, and a path connecting the component parts. During the course of the game, the playing pieces are moved along the path and the players answer questions from the question cards relating to various safety topics for the workplaces within the organization. The first player to answer questions successfully to each of the safety topics and return to the start position wins the game.

The present invention overcomes one or more deficiencies of the prior art.

### SUMMARY OF THE INVENTION

The present invention provides an interactive training apparatus and related kit for instructional training of individuals in railroad operations. It should be understood that while railroad operations are the implementation discussed herein, the present invention may have utility within other settings such as, but not limited to, freight trucking operations training or the like.

The present invention generally includes a table model board and associated pieces used for the purpose of instruction, demonstration, and testing of regulations and operating rules pertaining to railroad operations. With the invention, individual users of the invention are able to demonstrate their understanding of given regulations and operating rules as well as demonstrating their questions to an instructor.

In accordance with a first aspect, the present invention provides an interactive training apparatus for rail systems, the apparatus including: a table board having a front surface and a back surface, each the surface depicting rail system lines; a plurality of user pieces having an outer color, the outer color coordinated with a corresponding group of rail system elements; and a plurality of labels, each label corresponding to a rail system signal.

In accordance with another aspect, the present invention further provides a kit for interactive training within rail systems, the kit including: a table board having a front surface and a back surface, each the surface depicting rail system lines, the table board capable of being erasably written upon; a plurality of user pieces having an outer color, the outer color coordinated with a corresponding group of rail system elements, the user pieces capable of being customized; and a plurality of labels, each label corresponding to a rail system signal, the labels capable of adhering to the user pieces.

These and other aspects will become apparent from the following drawings and detailed descriptions of exemplary embodiments.

### BRIEF DESCRIPTION OF THE DRAWINGS

FIG. 1 shows a front side of a table board of a preferred embodiment of the present invention.

FIG. 2 shows a rear side of the table board in accordance with the present invention.

FIG. 3 show one example of a label sheet for customizing user pieces in accordance with the present invention.

FIGS. 4 through 7 show various manners of use in accordance with the present invention.

FIG. 8 shows one example of the components of a kit in accordance with the present invention.

### DETAILED DESCRIPTION

The following detailed description provides examples of presently contemplated modes of implementing embodiments of the invention. This description is not to be taken in a limiting sense, but is made merely for the purpose of illustrating general principles of embodiments of the invention. The scope of the invention will be best defined by the claims.

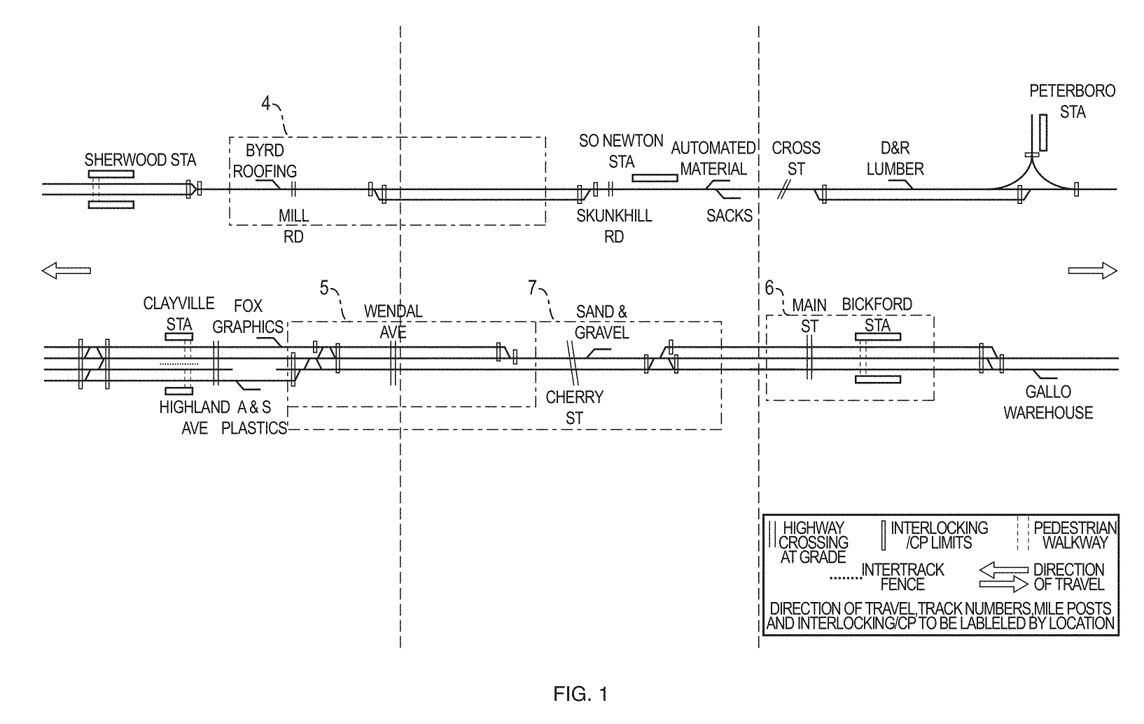

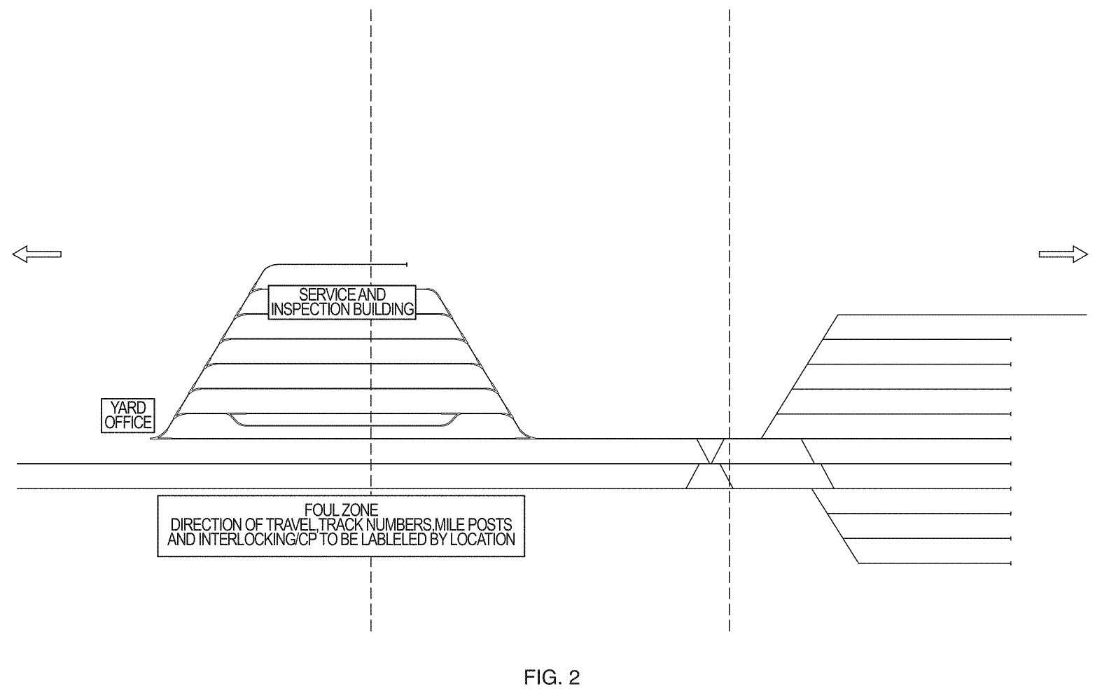

The present invention is embodied in a table board that includes a layout imprinted on its surface. FIGS. 1 and 2 show, respectively, a front surface and a back surface of the table board in accordance with the invention. The table board itself consists of a one-piece flat surface structure made from a rigid or semi-rigid material. The table board may include folds such that the structure is a bi-fold or tri-fold surface or any suitably foldable structure which produces a desired overall size when in use. Similarly, the table board may alternatively be formed by a multi-piece structure. The layout imprinted upon the table board surface provides full color lines, figures, and symbols which indicate different track configurations, sidings, yards, industrial and running tracks, highway crossings at grade, passenger stations, under grade bridges, and other similar railway system features as appropriate.

The table board is provided with a surface able to be written upon and erased in a manner such as, but not limited to, dry erase markers. In this way, the table board may be used by an instructor or student with a dry erase pen to show various railroad scenarios while still being erasable and therefore reusable.

The present invention also includes a set of associated user pieces. The user pieces may be in any desired shape or form. However, a generalized rectangular boxlike shape is preferred. The pieces may be color coded to indicate types of general categories of elements typically found within the rail system. Such categories may include railyard elements, train elements, passenger elements, street elements, or any distinct category of element known within the rail system. For example, user pieces indicating train elements may be provided in the color red while user pieces indicative of street elements may be provided in the color blue. It should be understood that any such color scheme for the various categories of train system elements may vary without straying from the intended scope of the present invention.

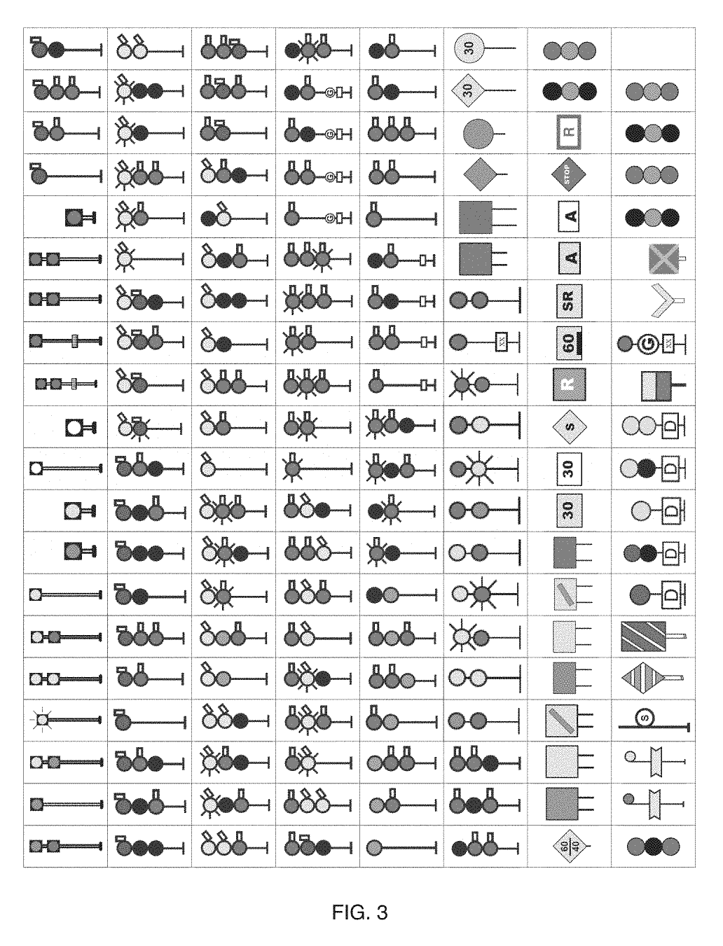

Because the user pieces are a generalized shape with a color for general categories of rail system elements, the user pieces themselves therefore are further modifiable via custom labels. Such custom labels are provided in the form of stickers. FIGS. 3 through 5 show a variety of sheets having custom labels in accordance with the present invention. Preferably, the stickers are grouped together on sheets whereby one sticker at a time may be removed from the sheet and attached by the user to any given user piece as appropriate. For example, custom labels indicative of the various rail system signals may be provided together on a single sheet. Likewise, custom labels indicative of the various train and track cars may be provided on another single sheet. In this manner, an assortment of custom labels may be grouped on a variety of sheets according to their logical category of train system element. The stickers which form the labels may be removable from a given user piece or may be placed over existing stickers on the given user piece.

The present invention may be used in a classroom setting whereby an instructor would select from the custom labels to create user pieces appropriate for demonstration of a rail system operation scenario. The customized user pieces may then be placed upon the table board in an appropriate manner to act out or otherwise demonstrate the given scenario. Additionally, an erasable marker may be used to modify the table board surface so as to indicate things such as, but not limited to, direction of movement along a track, flow of pedestrian traffic at a station, or the like. As well, the marker may be used to modify the rail lines to further vary the possible scenarios of rail system operation. Similarly, a student may use the same user pieces and erasable marker in conjunction with the table board to demonstrate their knowledge of a particular scenario.

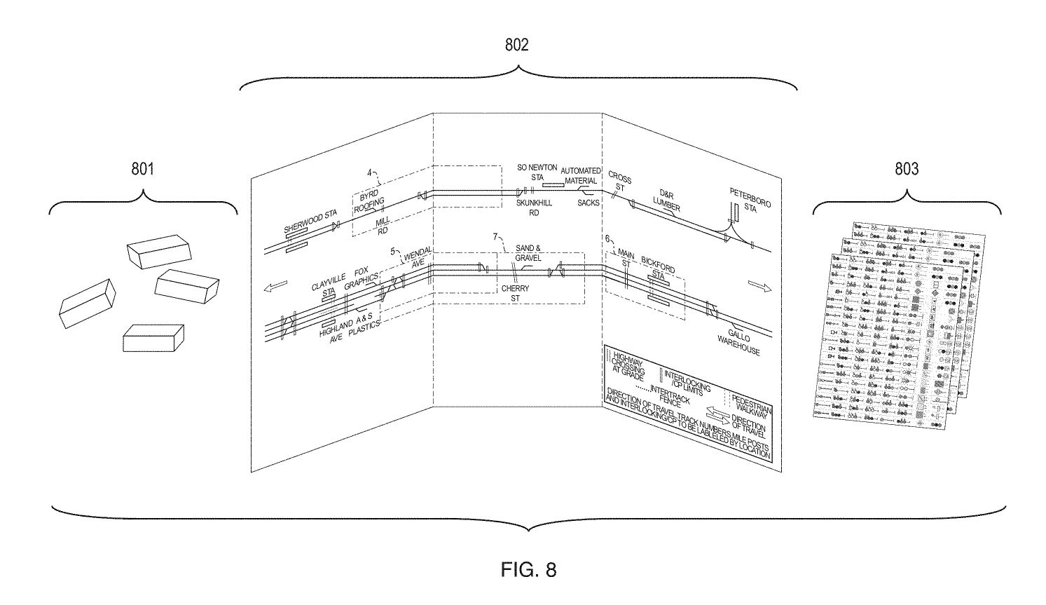

The present invention is therefore a mechanism by which a user may demonstrate or otherwise physically illustrate a rail system scenario. The invention itself may be provided together as a usable system including the table board and customized user pieces. Alternatively, the invention may be provided as a kit as shown collectively in FIG. 8 which may include a table board 802, generalized user pieces 801, and one or more sheets of labels 803 for use customizing the generalized user pieces. It should be understood that the user pieces may represent train elements or various train system operational elements. The sheets of labels may be organized in any manner such as, but not limited to, multiple sheets each being of a particular group of elements or a single sheet have a limited number of labels for multiple groups of elements on the single sheet. In this manner, a variety of different kits may be provided without straying from the intended scope of the present invention.

Each kit may include a starter pack of sheets with a minimum number of labels with which to customize the user pieces. Additional sheets of various configurations may be provided subsequent to initially obtaining a kit. In this manner, a basic kit may be provided with additional customization with purchase of additional sheets. The additional sheets may include, for example, sheets related solely to passenger train service in a public rail service setting or, alternatively, solely related to freight train service in an industrial shipping yard setting. It should therefore be readily understood that many other variations may be possible without straying from the intended scope of the present invention.

The present invention is useful for both entry level and seasoned railroad employees. The invention may be used for measuring learning goals in accordance with railroad regulations which mandates organized lesson plans with measurable goals and quantifiable results. Secondary uses may include accident reconstruction or rules violations reenactment as well as demonstrating questions relating to railroad rules and regulations.

The present invention provides a mechanism by which training of railroad personnel may adhere to the statutory requirement set forth in the Rail Safety Improvement Act of 2008 found in Title 49 of the U.S. Code of Federal Regulations at Part 243 (49 CFR Part 243). Those regulations ensure that any person employed by a railroad or a contractor of a railroad as a “safety-related railroad employee” is trained and qualified to comply with any relevant Federal railroad safety laws. The present invention may be used for dispatcher training as well.

A safety-related railroad employee may include: employees covered by the hours of service laws; employees performing work as an operating employee (including supervisors), even if not covered by the hours of service laws, all engineering/maintenance-of-way (MOW) including bridge workers who inspect, install, repair, or maintain track, roadbed, signal and communication systems, mechanical personnel who inspect, install, or repair any locomotive, passenger car, freight car, or MOW vehicle; any person who, as a primary duty, directly instructs, mentors, inspects, or tests others engaged in a safety-related task (including first line supervisors of operating employees); supervisors who determine that an on-track roadway maintenance machine or hi-rail vehicle may be used without repair of a noncomplying condition; and persons who perform oversight roles rather than doing the work themselves.

In conjunction with 49 CFR Part 243, the Northeast Operating Rules Advisory Committee (NORAC) provides a set of operating rules for railroads in North America referred, appropriately, as the NORAC Rules. The NORAC rulebook is used by full and associate member railroads, located mostly in the Northeast United States. The NORAC Rules are intended to enhance railroad safety. The rules cover employee responsibilities, signaling equipment, procedures for safe train movement, dealing with accidents and other topics that directly and indirectly affect railroad safety. These rules govern operation on main lines, defined as those with some form of block control system. The 11th edition of the NORAC Operating Rules went into effect on Feb. 1, 2018 as published by the Northeast Operating Rules Advisory Committee, a copy of which is publicly available and herein incorporated by reference in its entirety.

The following description illustrates examples of ways in which the present invention may be utilized.

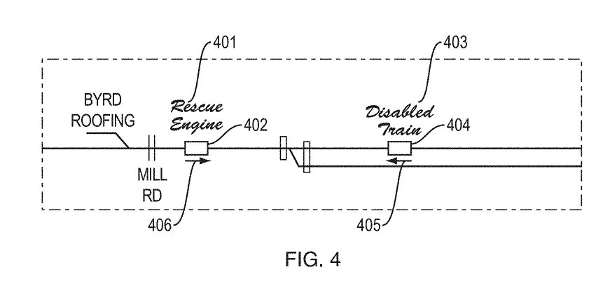

FIGS. 4 through 7 are close-up illustrations which correspond to the dotted line boxes enumerated in FIG. 1. FIG. 2 is used for instructing on CFR Part 218 “Leaving Equipment in the Clear, Position of Switches and Good Faith Challenge” also Rule 16 “Blue Flag Protection”. FIG. 2 may also be used to instruct on air brake instructions and requirements.

Using the present invention, an individual student learning railroad safety is able to demonstrate application of the NORAC operating rules as well as being able to illustrate any questions they may have pertaining to the rules and rail operation. By using the present invention, the student is also able to translate their declarative knowledge to procedural knowledge in a measurable way achieving level five of Bloom's Taxonomy as required by 49 CFR part 243 whereby the student at this level tries to build abstract knowledge. References to NORAC Rules are used for the following explanations. However, it should be readily understood that the scenarios used may pertain to all operating rule books.

FIG. 4 illustrates NORAC rule 137 “Assisting an Attended Disabled Train” and corresponds to dotted line box 4 in FIG. 1.

NORAC Operating Rule 137, in relevant part, states:

137. Assisting An Attended Disabled Train

a. Opposing Movements in Rule 261 Territory
To assist a disabled train, the Dispatcher may permit an opposing movement in Rule 261 territory. Before giving this authorization, the Dispatcher must issue Form D line 8 to the disabled train. A crew member of the disabled train must provide flag protection against the opposing movement as prescribed in part (e) below. The Dispatcher must then issue Form D line 9 to the assisting train. ABS rules will not apply to this movement.

e. Flag Protection Against Assisting Train
To provide flag protection against an assisting train as required by parts (a) through (d) above, an employee equipped with flagging equipment must proceed in the proper direction ¼ mile, and display a lighted fuse when the assisting train is seen or heard approaching. The employee must remain at that location until the assisting train arrives, or until the employee is recalled.

f. Assisting Train in Close Proximity or Operated by Engineer of Disabled Train
The provisions of parts (a) through (e) above will not apply when: 1. The disabled train is stopped within ¼ mile of the interlocking or CP where the assisting train will begin its opposing or following movement, and communication between the crews is maintained, or
2. The assisting train is operated by the Engineer of the disabled train. After receiving proper signal indication or verbal permission in accordance with Rule 241, the assisting train must operate at Restricted Speed to the disabled train.

With reference to FIG. 4 and with regard to the above stated NORAC Operating Rule 137, the individual using the invention demonstrates application of the operating rule pertaining to an opposing rescue scenario. It should be noted that the user may be either a student demonstrating their knowledge or an instructor illustrating proper methods. Here, an operating piece 402 of a first color is designated as a rescue engine. The individual user (student or instructor) then indicates by erasable marker the term “rescue engine” 401 or the like along with an arrow 406 indicating the intended direction of movement for the rescue engine. Likewise, the user indicates by erasable marker the term “disabled train” 403 or the like along with an arrow 405 indicating the intended direction of movement for the disabled train represented by a second operating piece 404. When using the invention, the procedural requirements become readily illustrated and easily understood. Under this scenario, the user will be able to understand the NORAC Form D requirements as well as when these requirements are not necessary for assisting trains.

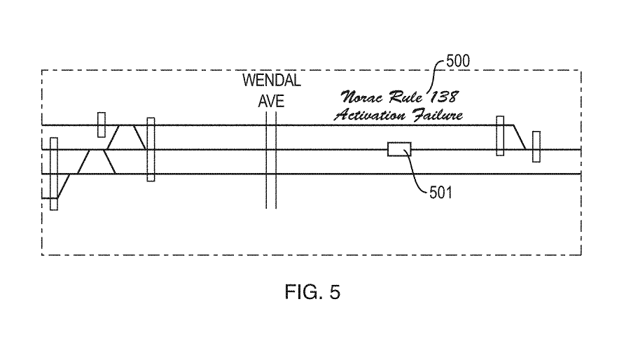

FIG. 5, which corresponds to dotted line box 5 in FIG. 1, refers to NORAC rule 138 “Highway Crossing Warning” item “C Malfunction” in conjunction with Timetable Special Instruction 138-S4 in the Northeast Corridor Timetable #7 at page 264 thereof. With reference to FIG. 5 and with regard to NORAC Operating Rule 138, activation failure is therefore illustrated.

More specifically, NORAC Operating Rule 138, in relevant part, states:

138. Highway Crossing Warning
a. Activating/Reactivating Crossing Warning
c. Malfunction

Notify the Dispatcher immediately if you discover automatic highway crossing warning devices that are not functioning properly.

The Dispatcher must:

1. Notify all trains that will operate over the affected crossing. This notification must include the type of malfunction and the details of any on-ground

personnel that are known to be at the crossing, by item number listed below.

AND

2. Ensure notification is provided to the local law enforcement agency or railroad police.

When the Dispatcher is notified that rust or other foreign matter may prevent effective shunting, trains must be instructed to comply with Item 1 below unless flagger or a railroad police officer is providing warning at the crossing.

The appropriate engine whistle or horn signal must be sounded at locations where automatic highway crossing warning devices are not functioning properly, including crossings where a whistle sign indicating “W/R” is displayed, and in areas otherwise designated as Quiet Zones.

138-S4. HIGHWAY CROSSING WARNING DEVICE MALFUNCTIONS

In the application of Rule 138, part “c”, the first five paragraphs (entire portion above table), are revised as follows:

Notify the Dispatcher immediately if you discover automatic highway crossing warning devices that are not functioning properly.

Once notified of malfunctioning automatic highway crossing warning devices, the

Dispatcher must:

1. Issue Form D Line 12 to all trains that will operate over the affected crossing, indicating the name and milepost of the crossing as identified in the applicable special instruction.

AND

2. Ensure that notification is provided to the local law enforcement agency or railroad police.

Unless otherwise instructed on Form D Line 13, crews must comply with the “Requirements” listed in Item 1 of Rule 138 part “c”: Stop, make certain that a crew member provides on-ground warning at the crossing, then proceed not exceeding 15 MPH until the leading end operates through the crossing.

When the Dispatcher is notified that rust or other foreign matter may prevent effective shunting, trains must be instructed to comply with the “Requirements” listed in Item 1 of Rule 138 part “c”, unless flagger or a railroad police officer is providing warning at the crossing.

The appropriate engine whistle or horn signal must be sounded at locations where automatic highway crossing warning devices are not functioning properly, including crossings where a whistle sign indicating “W/R” is displayed, and in areas otherwise designated as Quiet Zones

In this scenario as illustrated by way of FIG. 5, the individual using the invention will demonstrate the requirements of NORAC Rule 138 related to activation failures at highway crossings at grade, as well as the requirements of the Special Instruction (138-S4) by placement of an operating piece 501 at a line crossing and provide written indication 500 of the rule and situation. This may be accompanied by an oral description of given different scenarios for certain situations and by applying the rule accordingly.

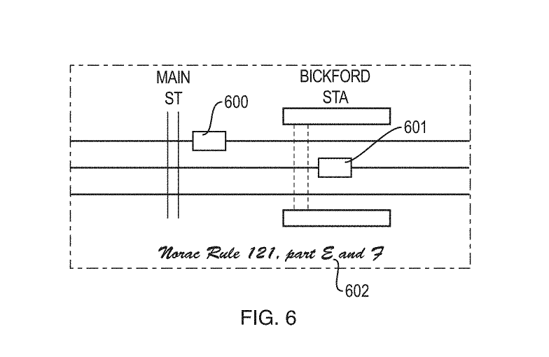

FIG. 6 deals with NORAC rules 121 “Intervening Tracks at Station Platforms” parts ‘B, E and F”. With reference to FIG. 8 and with regard to NORAC Operating Rule 121, operations with regard to a pedestrian crossing is illustrated.

More specifically, NORAC Operating Rule 121, in relevant part, states:

121. Intervening Tracks at Station
a. General Requirements

When a passenger train is receiving or discharging passengers across an intervening track, trains and track cars must not pass between that train and the station platform.
b. Obtaining Assurance of Protection

A passenger train routed to a track that will result in a station stop for receiving or discharging passengers across a main track or controlled siding intervening between that train and the station platform must stop as soon as it is known it is so routed. Before proceeding, the Engineer or Conductor must obtain assurance from the Dispatcher or Operator that protection on the track adjacent to the station platform has been provided. Two exceptions to the stop requirement are:

1. When verbal or written assurance of protection has been previously provided.

2. When the track adjacent to the station platform is out of service.

The Dispatcher or Operator must not give a train assurance of protection until it has been determined that:
1. No train is approaching the station on the track to be protected.
or
2. All trains involved have been advised as to how to proceed to ensure passenger safety.

Signals governing entrance to the track must be placed in stop position and blocking devices must be applied.
c. Receiving and Discharging Passengers: Designated Stations

Specific stations are designated in the Timetable as those where scheduled trains normally receive and discharge passengers across a track between the train and the station platform. Protection against other trains is not required when trains make scheduled stops at these stations.

Trains operating on tracks across which passengers are normally received and discharged must approach such stations prepared to stop, until the Engineer has determined that no passenger train is occupying the station by:

1. Visual observation.

or

2. Verbal confirmation from the Dispatcher.

If a passenger train is occupying the station, the approaching train must not occupy the station unless permission is received from the crew of the train occupying the station and measures have been taken to ensure the safety of its passengers.
d. Occupying Station Platform Area

When a passenger train is approaching, the station platform area must not be occupied by either:
1. Trains operating on an out-of-service track that is adjacent to a station platform.
or
2. Track cars operating on a track (in-service or out-of-service) that is adjacent to a station platform.
e. Blocking Access to Platform

At stations where tracks intervene between a station platform and a track on which passenger trains normally receive or discharge passengers, trains other than passenger trains must not block access to the platform.

FIG. 6 illustrates NORAC Rule 121 and may be used by individual user to explain how the rule is applied to different situations. Here, operating pieces 600 and 601 are shown at a station on different lines within the pedestrian crossing area. Rule 121 is used to protect pedestrian crossings at station platforms where no other crossing protection is provided or practical. When Rule 121, part b is used the Dispatcher or Operator will protect the crossing from approaching movements. Whereas Rule 121, part E and F puts the requirement on the train crews. Accordingly, the present invention may be used for train dispatcher training. The student using the invention will be able to act out the rule with the operating pieces 600 and 601 accompanied by written notations 602 placed by the student onto the board while explaining the procedures to be followed when a train is occupying the platform.

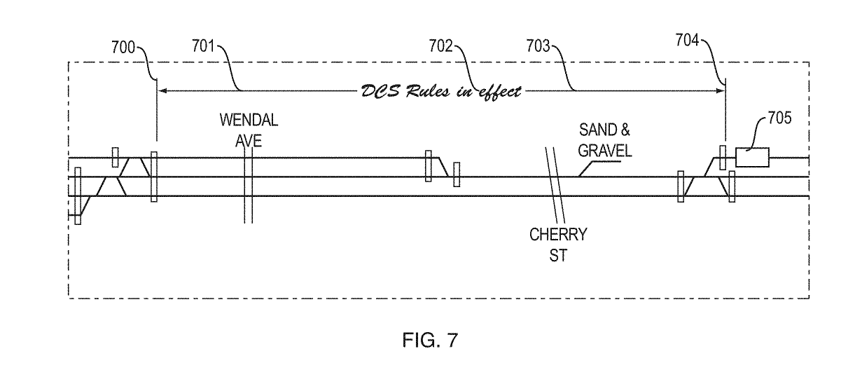

FIG. 7 illustrates NORAC rule 406 “ABS Failure; Non-signaled DCS Substitution” parts A, B and C and also Rule 401 “operating in Non-signaled DCS Territory” part A and B and Rule 402 “Operating in a Specified Direction” parts A, B and C. With reference to FIG. 7 and with regard to NORAC Operating Rule 406 and Rule 401, operations with regard to a distributed control system (DCS) is illustrated.

More specifically, NORAC Operating Rules 406 and 401, in relevant part, state:

406. ABS Failure: Non-signaled DCS Substitution

a. Form D Line 6 or Bulletin Order

When an ABS failure occurs, non-signaled DCS rules may be substituted by Bulletin Order or Form D line 6.

All trains and Operators affected must receive a copy of the Form D line 6 or Bulletin Order. Before the Dispatcher issues the Form D line 6 or before the Bulletin Order becomes effective, the Dispatcher must ensure that:
1. Interlocking and CP signals governing entrance to or within the affected limits are in Stop position,
AND
2. Blocking devices are applied to the controls of switches and signals leading to the affected limits.

Interlocking or CP signals governing entrance to or within the affected track may be displayed to authorize movements that have received Form D line 2 authority. Signal indication will govern movement within interlocking limits or CP only. These signals must be immediately restored to Stop position and blocking devices reapplied once the head end of the authorized movement has passed the signal.
b. Rules-in-effect

ABS and CSS rules do not apply when non-signaled DCS rules are substituted for

ABS.

### 401-S2. OPERATING IN NON-SIGNALED DCS TERRITORY: MAXIMUM AUTHORIZED SPEED

NORAC Rule 401(a) has been revised to comply with the Federal requirements in 49 CFR Part 236.0 reducing the maximum authorized speeds.

### 401. Operating in Non-Signaled DCS Territory

a. Maximum Authorized Speed

Passenger trains must not exceed 59 MPH and freight trains must not exceed 49 MPH, unless otherwise restricted

FIG. 7 illustrates what an individual using the present invention board and operation piece 705 would indicate is the scenario when a DCS signal substitution applies due to a failure of wayside signals. DCS rules could apply to all tracks or just one track in the affected area. With this scenario, the limits 700, 704 may be indicated using written notations 702 and arrows 701, 703 while the student through use of the operation piece 705 and board will explain and demonstrate the procedures used in each step that allow movement through the affected area.

In addition to the examples shown in FIGS. 4-7, the present invention may be used for all crafts operating equipment over the railroad not just train crews. Moreover, the present invention may be used to illustrate all track equipment movements which include transiting equipment, clearing the limits of authority, receiving additional authorities, permissions past stop signals, out-of-service tracks and the associated rules, protection of work areas, signal progressions that pertain to trains and track equipment, or any related scenario or combination of scenarios without straying from the intended scope of the invention.

The foregoing description of certain embodiments of the invention has been presented for the purposes of illustration and description. It is not intended to be exhaustive or to limit the invention to the precise form disclosed. Many modifications and variations are possible in light of the above teachings. Therefore, it is intended that the scope of the invention be limited not by this detailed description, but rather by the claims appended hereto.

What is claimed is:

1. An interactive training apparatus for rail systems, said apparatus comprising:
a table board having a front surface and a back surface, each said surface depicting rail system lines;
a plurality of user pieces having an outer color, said outer color coordinated with a corresponding group of rail system elements; and
a plurality of labels, each label corresponding to a rail system signal.

2. The apparatus as claimed in claim 1 wherein said front surface and said back surface of said table board is erasable.

3. The apparatus as claimed in claim 2 wherein said user pieces are formed in a shape having at least one surface suitable for placement of one or more of said plurality of labels.

4. The apparatus as claimed in claim 3 wherein the table board is a single foldable structure.

5. The apparatus as claimed in claim 4 wherein the table board is fabricated from a rigid material.

6. The apparatus as claimed in claim 4 wherein the table board is fabricated from a semi-rigid material.

7. A kit for interactive training within rail systems, said kit comprising:
a table board having a front surface and a back surface, each said surface depicting rail system lines, said table board capable of being erasably written upon;
a plurality of user pieces having an outer color, said outer color coordinated with a corresponding group of rail system elements, said user pieces capable of being customized; and
a plurality of labels, each label corresponding to a rail system signal, said labels capable of adhering to said user pieces.

8. The kit as claimed in claim 7 wherein said user pieces are formed in a shape having at least one surface suitable for said adhering of one or more of said plurality of labels.

9. The kit as claimed in claim 8 wherein the table board is a single foldable structure.

10. The kit as claimed in claim 9 wherein the table board is fabricated from a rigid material.

11. The kit as claimed in claim 9 wherein the table board is fabricated from a semi-rigid material.

12. The kit as claimed in claim 7 further including at least one sheet capable of providing additional labels for customization of said user pieces.
